(19) United States
(12) Patent Application Publication
(10) Pub. No.: US 2010/0049660 A1
(43) Pub. Date: Feb. 25, 2010

(54) PROCUREMENT SYSTEM

(75) Inventor: Thomas Reichhart, Aldenhoven (DE)

Correspondence Address: URSULA B. DAY, ESQ., 708 Third Avenue, SUITE 1501, NEW YORK, NY, 10017, US

(73) Assignee: Hiflex Software Gesmbh, Wien (AT)

(21) Appl. No.: 12/441,477

(22) PCT Filed: Sep. 13, 2007
(86) PCT No.: PCT/EP2007/007977

§ 371 Date: Mar. 16, 2009

(30) Foreign Application Priority Data
Sep. 18, 2006 (DE) 10 2006 044 340.3

(51) Int. Cl. G06Q 30/00; G06Q 10/00

(52) U.S. Cl. 705/80; 705/26; 705/7

(57) ABSTRACT

The procurement system includes that a quotation regarding the request for quotation can be only submitted by a seller through means of the procurement system, when he is registered and also personally identified in the procurement system so he is known as a seller with separately defined contact data and irrespective of the contact data in the list of the buyer whereby the seller determines his own billing address in the procurement system and thus prevents sending an invoice for example to other contacts, departments or divisions of the corporate group not related to the quotation.

The invention relates to a procurement system by means of which a project and an individual contact list is definable, a plurality of contacts is selectable from the list and a request for quotation regarding the project is transmittable to the selected contacts by a buyer, and by means of which incoming quotes are receivable and associatable with the request for quotation.

Such a procurement system, in particular for print products, is known as individual software under the designation “P3Expeditor” of P3 Software Inc., 81 Speen St., Natick, Mass./USA (www.p3software.com). The prior art procurement system is installed on the system for the buyer of print products and organizes his previously manual activity from managing a list of contacts of potential sellers through describing print products, selecting the contacts from the list, formulating the individual requests for quotation, and sending them via e-mail to the selected contacts, up to receiving the quotes coming in thereafter and comparing and evaluating them.

As a background of the invention, so-called “Requests for Quotation” are known as a partial step of issuing jobs in competitive bidding. In the context of a request for quotations, registered potential sellers are asked by a request to submit a binding quotation (in a Government context “Request for Proposal”, RFP; in a commercial context: “Request for Quotation”, RFQ). In the context of a request for quotation, requests are only sent to potential sellers, which have previously registered themselves for this purpose. On the other hand, a procurement system according to the invention as a tool of the buyer is substantially based on the “simple” list of his contacts defined by himself, which namely in particular have not been stored through the registration by third parties.

In the wider context of the invention, so-called “Job Exchanges”, like e.g. quotatis (www.quotatis.de), are known. Here, a buyer can define a project, can publish it in the form of a request for quotation, and can “auction” it in a reverse public auction, wherein a seller receives the job award, when he submits the most competitive bid. In such a job exchange, a request for quotation, differently from procurement system according to the application is not transmitted to contacts individually selected by the buyer. Rather typically, the seller remains anonymous to the buyer at least until he issues a quote. The system only subsequently establishes the direct contact between the (successful) seller and the buyer.

The known procurement system, on the one hand, requires an investment by the buyer, and, on the other hand, which is more significant in particular in larger companies with more restrictive safety and authorization concepts, the known procurement system requires installation at his local workstation. Request for quotation methods and job exchanges though are implemented as web applications (thus do not require local installation) and are typically financed by contributions of the respective sellers, whose bids have succeeded, however, they cause a system specific turning away from the individual contact list and from the direct request for quotation from selected contacts, depending on the respective task at hand. The customary mode of operation of the buyer, which considers particular subject matter knowledge of the task at hand and the particular experiences with particular sellers, is not possible when using the known request for quotation methods and job exchanges.

### OBJECT OF THE INVENTION

It is the object of the invention to facilitate allocating the operating cost of a procurement system to the seller.

### Solution

Based on the known procurement system, it is proposed according to the invention that a quotation regarding the request for quotation is only submissible by a seller by means of the procurement system, when he is registered and also personally identified in the procurement system. Submitting a quotation through a seller by means of the procurement system according to the invention requires, on the one hand, that the seller is registered in the procurement system, thus that he is known as a seller (with separately defined contact data), thus irrespective of the contact data in the list of the buyer. Thus, the seller determines, in particular, his own billing address in the procurement system according to the invention, and prevents sending an invoice e.g. to other contacts, departments or divisions of the corporate group not related to the quotation.

The contact data in the list of the buyer is no reliable basis for allocating and billing costs in principle. In real life operations, requests for quotations are typically forwarded by the original recipients to third parties, in particular to specialized departments of their own company, or to external cooperation partners. A restriction in the sense that a quotation responding to a request for quotation can only come from the initially interrogated contact is not the intention of the buyer. The procurement system according to the invention facilitates a uniform identification of the seller, and thus compiling a total invoice for the seller, comprising several quotations to different buyers, irrespective of possibly faulty address data of the buyers.

The additional data structure of the procurement system according to the invention for the contact data of the registered sellers already facilitates a billing of incurred costs to those sellers in principle. However, only the individual registration of the seller when issuing a quotation facilitates associating the quote specific operating costs of the procurement system to this seller. The cost for using the procurement system according to the invention can thus be billed to the seller and not to the buyer, like in the prior art procurement system.

The communication between buyer and seller through at least partially automatically generated and processed e-mails is desirable in order to simplify and accelerate the procurement process. Alternatively, project descriptions, requests for quotation and quotations, later in the process, also job orders and rejection letters and status reports regarding the progress of the project can also be communicated in other formats, in particular as attachments of emails or through specific interfaces, e.g. in a XML based format. In the printing industry, the “Job Definition Format” (JDF) is being increasingly used for this purpose.

In a preferred embodiment, a procurement system according to the invention can be used for a plurality of buyers through a web portal, wherein the procurement system provides a respective individual list of contacts for potential sellers. The use of the procurement system according to the invention through a web portal relieves the buyer of the necessity to perform an installation at its local workstation.

Furthermore, such a procurement system according to the invention not only facilitates the use by several buyers, but does not require, contrary to the known auction and request for quote method, a “critical mass” of participating buyers and sellers for its operation. The procurement system according to the invention can already be advantageously used by a single buyer (without registered sellers).

Alternatively, a procurement system according to the invention can also be implemented in the context of individual software, when a buyer e.g. does not have access to the internet. An incoming quotation (via telephone or in writing) can e.g. also be manually entered by the buyer into a system locally installed on the workstation of the buyer. The identification as a registered seller could be performed in such case through an identifier (e.g. a so-called “Transaction Number”, TAN), previously transmitted to the seller by the procurement system for a quotation.

Preferably, a procurement system according to the invention can transmit to each buyer a list of the projects defined by him, the transmitted requests, the received quotations and the awarded jobs, and can transmit to each seller a list of the quotes issued by him. Thus, the buyer and the seller maintain an overview of the actions performed by the procurement system all the time.

Preferably, a procurement system according to the invention comprises an interface for transmitting the project to the procurement system. With buyers who frequently request quotes for large projects, these projects are often described in other systems in specific formats. In larger companies, projects are often managed by ERP Systems (e.g. SAP); in the printing industry, they are increasingly managed by JDF-based systems. Then a buyer can transmit the project, which is already defined, directly from his ERP system or from a JDF-based system through the interface to the procurement system according to the invention.

Furthermore, a quote is selectable, particularly preferably by means of a procurement system according to the invention, and a job can be issued according to a selected quote. This augmentation of the procurement system according to the invention facilitates and structures the procurement process further, while maintaining and using the data received previously in the context of defining the project, requesting the quotes and from the received quotations.

Preferably, such a procurement system according to the invention comprises an interface for transmitting status reports regarding the execution of an issued job to the procurement system. The procurement system according to the invention thus becomes a communication center between buyer and seller with respect to all processes related to the project. With sellers who frequently execute large projects, these projects are often managed in other systems; in larger companies e.g. by means of ERP Systems, and in particular in the printing industry, increasingly managed by JDF-based systems.

Known ERP Systems, as well as JDF-based systems, can transmit frequent status reports regarding the execution of a project to an external address. When these status reports are transmitted to the procurement system according to the invention, e.g. from an ERP System or in “Job Messaging Format” (JMF) as a subgroup of JDF, they can be automatically processed therein, and in particular, can they be displayed to the buyer in an easily understandable graphic illustration.

Particularly preferably, such a procurement system according to the invention comprises an interface for transmitting status reports regarding an issued job through the procurement system. When the status reports from the procurement system according to the invention are forwarded through such an interface, e.g. directly to an ERP System or to a JDF-based system of the buyer, then this ERP System or JDF-based system can completely take over the control or monitoring of the project specific processes managed in the system according to the invention. Using a proper (web based) user interface of the procurement system according to the invention is not required anymore then.

### EMBODIMENT

The invention is subsequently described based on two exemplary processes of purchases, including the subsequent execution of the projects, and the billing of the operating cost of the procurement system according to the invention, which can be used through a web portal with the address www.printsupport.com.

A buyer of print industry products, thus of print products in the largest sense, is registered in the procurement system, and initially transmits a project from his ERP System regarding the print production and delivery of product displays through the internet and its SAP interface to the procurement system. The ERP System is identified in the procurement system through its “Unified Resource Locator” (URL) and it is associated with the login of the buyer. The buyer receives an automated e-mail from the procurement system regarding the receipt of a new project with a link, which directly links him through a login page to a web form in the procurement system for further working on said project.

In the procurement system, the buyer has provided with a link to the list of potential sellers listed in his department in a database, which list has indications of the respective particular capabilities of said sellers, and with respect to business data, e.g. regarding agreed upon minimum purchase orders, and he has issued a reading authorization for said database to the procurement system. From said list, the buyer selects four contacts for the new project by means of the procurement system, and transmits a respective request for quotation to each of them through the procurement system, which request includes a request for quotation of the production and delivery of the product displays.

The first contact is obsolete; the first request for quotation is lost. The buyer receives an error message by e-mail regarding the failed delivery and marks the first contact in his list as possibly obsolete.

A second request is delivered via e-mail to an employee of a printing company, who in the meantime does not work on generating quotations anymore, but who forwards the request via telephone to a colleague in charge. Said colleague opens the particular webpage quoted in the e-mail with his internet browser, which webpage is included in a procurement system still unknown to him, and he immediately arrives at the request for quotation of the buyer regarding the product displays without identifying himself. From the request, he derives the contact data of the buyer and submits a quotation to him via telephone. The buyer manually transfers the data of said quotation into a form associated with the second request for quotation and updates his contact data according to the respective information by the seller.

A third request reaches a second JDF-based completely networked printing company, which is already registered as a seller in the procurement system. An attachment of the e-mail in JDF is automatically read out and is forwarded as a request to the Central Management Information System (MIS). In the MIS, the request automatically initiates a preliminary job costing, whose result is transmitted to the respective specialist in the form of a quote for approval, before it is sent out. The specialist supplements the quote with a reference to current items and services on sale, reduces the final price according to an existing discount agreement with the buyer and sends the quote through the MIS back to the procurement system. The MIS in turn is identified in the procurement system through its seller number and is associated with the second print company.

A fourth request reaches an employee responsible for quote preparation in a third printing company via e-mail, which company is also registered in the procurement system as a seller. The employee opens the web interface of the procurement system through the particular link included in the e-mail and selects the option “quote submitted” therein. In the subsequent web form, he initially identifies himself through his personal identifier and enters the data of his quote himself.

The buyer receives a message via e-mail that all outstanding requests for quotation have been processed now, and he in turn registers through a particular link in the web interface of the procurement system. Comparing the quotes, the buyer recognizes that the first quote manually entered by him includes the most competitive conditions. He selects this quote and confirms the job issue to the second print company via telephone and also informs the other two bidders regarding the result of the process via telephone.

In the same procurement system, several specialized print companies, which are organized in a regional cooperative, are registered as buyers and also as sellers. All these companies are completely networked internally through a JDF-based MIS. One company receives a request to produce and deliver a high gloss brochure for a share holder assembly. The project description comprises two specifications, which the requested company cannot perform itself: a Leporello insert and gold plating on the front of the brochure.

In the context of costing the entire project, the MIS of the company automatically sends project descriptions for the Leporello and for the gold plating through the JDF interface to the procurement system. Simultaneously with the project description, the MIS respectively sends a selection of the contacts to which the request for quotation is to be sent, included therein are respectively also other companies of the cooperative.

Directly after receiving the project descriptions, the procurement system sends the respective requests for quotation. The requests for quotation directed to companies of the cooperative are directly transmitted through a JDF interface to their MIS, processed there completely automatically and replied to with quotes. The quotes by the companies of the cooperative arrive at the procurement system with an insignificant delay after the requests for quotation have been sent out and are reported back directly to the MIS of the company quotations, which generates a quote for the production of the high gloss brochure based on the received information.

After the quote has been sent out, another company registers as a seller in the procurement system in response to the request to produce the gold plating. The specialist identifies himself by a “Personal Identification Number” (PIN) in the procurement system and issues a more competitive quote.

After the job for the high gloss brochure has been issued, the MIS of the buyer automatically issues the partial jobs for the Leporello and for the gold plating through the procurement system to the most competitive bidders. The registered sellers who were successful with their quotes are billed with the quote specific costs in a quarterly combined invoice.

Through the production and delivery of the Leporello, the procurement system continuously receives JMF status reports and forwards these to the MIS of the buyer. The buyer does not interfere with the web interface of the procurement system.

The procurement system according to the invention includes a module for supporting the selection of a seller. Besides the possibility, as described supra, to select the most competitive quotation, also a pre defined number of “most competitive” bidders can be preselected and can be transferred into an auction process.

1. A procurement system, by means of which a project and an individual contact list is definable, a plurality of contacts is selectable from the list and a request for quotation regarding the project is transmittable to the selected contacts by a buyer, and by means of which incoming quotes are receivable and associatable with the request, wherein a quote in response to the request for quotation can only be issued by a seller by means of the procurement system, when he is registered and also personally identified in the procurement system.

2. The procurement system according to claim 1 comprising a web portal, by means of which the procurement system is usable by a plurality of buyers, wherein the procurement system provides a respective individual list of contacts for each buyer.

3. The procurement system according claim 2, wherein a list is transmittable to each buyer, which comprises the projects defined by him, the requests for quotation transmitted by him, the quotes received by him and the jobs issued by him.

4. The procurement system according to list wherein a list can be transmitted to each seller which comprises the quotes issued by him.

5. The procurement system according to claim 1, comprising an interface for transmitting the project to the procurement system.

6. The procurement system according to claim 1, wherein a quote is selectable by means of the procurement system and a job is issuable according to a selected quote.

7. The procurement system according to claim 6, comprising an interface for transmitting status reports regarding the execution of an issued job to the procurement system.

8. The procurement system according to claim 6, comprising an interface for transmitting status reports regarding an issued job through the procurement system.
